(19) United States
(12) Patent Application Publication
(10) Pub. No.: US 2026/0100631 A1
(43) Pub. Date: Apr. 9, 2026

(54) METHOD FOR COMPENSATING CURRENT RECONSTRUCTION ERROR OF POWER CONVERSION SYSTEM USING SINGLE CURRENT SENSOR AND POWER CONVERSION SYSTEM THEREFOR

(71) Applicant: INCHEON NATIONAL UNIVERSITY RESEARCH&BUSINESS, Incheon (KR)

(72) Inventors: Hyeon-gyu CHOI, Incheon (KR); Min-Seok CHAE, Gwangju (KR); Jun-sik HWANG, Siheung-si (KR)

(21) Appl. No.: 18/979,440

(22) Filed: Dec. 12, 2024

(30) Foreign Application Priority Data
Oct. 4, 2024 (KR) 10-2024-0134786

(51) Int. Cl. H02M 1/00; H02M 7/5395

(52) U.S. Cl. CPC H02M 1/0009; H02M 7/5395

(57) ABSTRACT

Embodiments of the present disclosure provide a method of compensating for current reconstruction errors in a power conversion system, which includes: applying a voltage command to an inverter, measuring a DC-link current flowing through a DC side of the inverter, and reconstructing a phase current on the basis of the DC-link current, and the reconstructing of the phase current may include replacing a zero vector section with an active vector section, while maintaining symmetry of a switching waveform for a plurality of switching elements included in the inverter, and reconstructing an average current.

### CROSS-REFERENCE TO RELATED APPLICATION(S)

This application is based on and claims priority under 35 U.S.C. 119 to Korean Patent Application No. 10-2024-0134786, filed on Oct. 4, 2024, in the Korean Intellectual Property Office, the disclosure of which is herein incorporated by reference in its entirety.

### BACKGROUND OF THE INVENTION

### 1. Field of the Invention

The present disclosure relates to a method for compensating for current reconstruction errors in a power conversion system using a single current sensor and a power conversion system using the same and, more specifically, to a method for compensating for current reconstruction errors in a power conversion system having a single DC-link current sensor using minimum voltage injection and switching signal split, and a power conversion system using the same.

### 2. Description of the Prior Art

An inverter system controls AC motors or the like using an inverter. In order to control a three-phase inverter system, which is a representative example of an inverter system, information of a three-phase current must be recognized. The inverter system may control an AC motor using a plurality of current sensors as shown in FIG. 1, or may control an AC motor using a single current sensor as shown in FIG. 2.

FIG. 1 is a drawing showing a conventional three-phase inverter system using a plurality of phase current sensors.

Referring to FIG. 1, the three-phase inverter system may include a DC power source 1 such as a battery, an AC motor 2, phase current sensors 3-1, 3-2, and 3-3, and an inverter 4. In the case of using current sensors 3-1, 3-2, and 3-3 arranged for each phase as in the three-phase inverter system in FIG. 1, the volume of the system increases and the cost of configuring the system increases because multiple current sensors 3-1, 3-2, and 3-3 are used.

In addition, during a process of sampling current information, the offset or scale may vary depending on the sensor tolerance and the characteristics of an A/D (Analog-to-Digital) converter, which may deteriorate the control performance for the AC motor. Therefore, in order to improve the control performance, it is necessary to compensate for the offset or scale errors. In this case, if a plurality of sensors are used, the tolerance varies among the sensors, so the errors to be compensated for increase in proportion of the number of sensors, making it more difficult to compensate for the errors.

FIG. 2 is a drawing showing a conventional three-phase inverter system using a single current sensor.

Referring to FIG. 2, the three-phase inverter system may include a DC power source 1 such as a battery, an AC motor 2, a DC-link current sensor 3, and an inverter 4, and may reconstruct three-phase current information using a single DC-link current sensor 3. Since the number of current sensors is reduced to 1, the volume of the system is reduced and the cost of configuring the system may also be reduced. In addition, since only one current sensor 1 is used, the errors to be compensated for may be reduced, compared to the case of using multiple current sensors.

However, when reconstructing the current using the single current sensor 3, there is a problem in which a dead zone occurs where the three-phase current cannot be reconstructed. In addition, the average current is also unable to be reconstructed. The problem of not being able to reconstruct the average current will be explained as follows.

Since the phase current has a fundamental wave component at the center or starting point of the switching cycle, the average value may be sampled at the center or starting point of the switching cycle. However, when switching with the space vector pulse width modulation (SVPWM), the current may be sampled by the DC-link current sensor only from an active voltage vector. As a result, the average current value is unable be sampled when switching with the space vector pulse width modulation, resulting in an average current error.

In addition, since the point of sampling current differs between two phases, the current at the first sampling and the current at the second sampling have a time difference therebetween. Therefore, the current value of the remaining one phase obtained by Kirchhoff's current law has no information about the time point within the switching period. This causes a time division error.

The concept of average control is applied to general three-phase inverter system. Therefore, the actual current should also be controlled using the average current in order to obtain excellent control characteristics without control errors. However, the average current error and time division error deteriorate the control performance of the three-phase inverter system.

FIG. 3 is a block diagram showing the control flow of a conventional three-phase surface-mounted permanent magnet synchronous motor using a DC-link current sensor.

Referring to FIG. 3, the control flow is shown when a three-phase surface-mounted permanent magnet synchronous motor (SPMSM) is driven by a single DC-link current sensor in order to explain the factors that deteriorate the control performance. The control of a general three-phase inverter system is controlled by converting the three-phase (AC) information of phases a, b, and c into information on two axes, i.e., d- and q-axes (DC) for the convenience of calculation. In the three-phase surface-mounted permanent magnet synchronous motor, the d-axis does not contribute to the motor power, so it is controlled as 0. In addition, a speed controller outputs a current, as a q-axis current command, proportional to the required power depending on the current load status.

However, the average current error and time division error also cause an average error in the current converted to the d- and q-axes. The average current error causes an error when estimating or calculating additional values required in the control and reduces accuracy. A representative example is a sensor-less algorithm that estimates the rotor position using the dq-axis current information.

In addition, the q-axis current command output from the speed controller also has an average error due to the average current sampling error. Therefore, even though the motor is in the operable state, the motor is unable to operate because the average error of the command exceeds the upper limit of restriction, thereby reducing the operation area. In addition, even if the real phase current actually exceeds the upper limit, a controller may fail to recognize this situation, so that the motor may continue to operate, causing damage to the motor.

In order to solve this problem, there is a method of sampling the average current by changing the existing space vector pulse width modulation method to another modulation method, but this method has a disadvantage in which the harmonic characteristics deteriorate, compared to when operating with the space vector pulse width modulation, if the speed increases to a certain value or more. In addition, another method is to reduce the error using an additional algorithm while applying the space vector pulse width modulation, but this algorithm is based on a model of using the parameter of the motor, and thus is sensitive to the parameter error of the motor.

### SUMMARY OF THE INVENTION

In order to solve the problems above, the present disclosure is to provide a method for compensating for current reconstruction errors in a power conversion system using a single current sensor, and a power conversion system using such a method.

An embodiment of the present disclosure provides a method of compensating for current reconstruction errors in a power conversion system, which includes: applying a voltage command to an inverter; measuring a DC-link current flowing through a DC side of the inverter; and restoring a phase current on the basis of the DC-link current, wherein the reconstructing of the phase current may include replacing a zero vector section with an active vector section, while maintaining symmetry of a switching waveform for a plurality of switching elements included in the inverter, and reconstructing an average current.

An embodiment of the present disclosure provides the method of compensating for current reconstruction errors in a power conversion system, wherein the reconstructing of the phase current includes splitting one of three-phase signals within a switching period in space vector pulse width modulation.

An embodiment of the present disclosure provides the method of compensating for current reconstruction errors in a power conversion system, the splitting one of the three-phase signals includes at least one of: splitting a phase signal corresponding to

$${v}_{max}^{*}$$

to generate a first switching waveform; splitting a phase signal corresponding to

$${v}_{mid}^{*}$$

to generate a second switching waveform; and splitting a phase signal corresponding to

$${v}_{min}^{*}$$

to generate a third switching waveform.

An embodiment of the present disclosure provides the method of compensating for current reconstruction errors in a power conversion system, the reconstructing of the phase current includes applying two switching waveforms alternately, among the first switching waveform, the second switching waveform, and the third switching waveform, and restoring the average current.

An embodiment of the present disclosure provides the method of compensating for current reconstruction errors in a power conversion system, the reconstructing of the phase current includes sampling an average current at a center point of switching, thereby reconstructing the phase current.

An embodiment of the present disclosure provides the method of compensating for current reconstruction errors in a power conversion system, wherein the inverter is controlled on the basis of space vector pulse width modulation, and the method further include, if an active vector application time of an output voltage command is shorter than a minimum active vector application time (Tₘᵢₙ), injecting a minimum voltage and measuring the DC-link current.

An embodiment of the present disclosure provides the method of compensating for current reconstruction errors in a power conversion system, wherein the minimum voltage is a voltage equal to a minimum distance to a recoverable area.

An embodiment of the present disclosure provides the method of compensating for current reconstruction errors in a power conversion system, which further includes, after measuring the DC-link current, compensating for a voltage in the opposite direction of the minimum voltage to maintain the average voltage.

An embodiment of the present disclosure provides the method of compensating for current reconstruction errors in a power conversion system, wherein the measuring of the current flowing through the DC side of the inverter includes measuring the current using a single DC-link current sensor disposed between the inverter and a DC power source.

An embodiment of the present disclosure provides a power conversion system including: a voltage command generator configured to apply a voltage command to an inverter; a current sensor configured to measure a DC-link current flowing through a DC side of the inverter; and a phase current reconstruction unit configured to restore a phase current on the basis of the DC-link current, and the phase current reconstruction unit includes a current reconstruction error compensator configured to compensate for a current reconstruction error by replacing a zero vector section with an active vector section, while maintaining symmetry of a switching waveform for a plurality of switching elements included in the inverter, and restoring an average current.

An embodiment of the present disclosure provides the power conversion system, wherein the phase current reconstruction unit is configured to split one of three-phase signals within a switching period in space vector pulse width modulation.

An embodiment of the present disclosure provides the power conversion system, wherein the phase current reconstruction unit is configured to generate at least one of a first switching waveform obtained by splitting a phase signal corresponding to

$${v}_{max}^{*} ,$$

a second switching waveform obtained by splitting a phase signal corresponding to

$${v}_{mid}^{*} ,$$

and a third switching waveform obtained by splitting a phase signal corresponding to

$${v}_{min}^{*} ,$$

among the three-phase signals.

An embodiment of the present disclosure provides the power conversion system, wherein the phase current reconstruction unit is configured to apply two switching waveforms alternately, among the first switching waveform, the second switching waveform, and the third switching waveform and reconstruct the average current.

An embodiment of the present disclosure provides the power conversion system, wherein the phase current reconstruction unit is configured to sample an average current at a center point of switching, thereby reconstructing the phase current.

An embodiment of the present disclosure provides the power conversion system, wherein the inverter is controlled on the basis of space vector pulse width modulation, and the phase current reconstruction unit is configured to inject, if an active vector application time of an output voltage command is shorter than a minimum active vector application time (Tₘᵢₙ), a minimum voltage and measure the DC-link current.

An embodiment of the present disclosure provides the power conversion system, wherein the minimum voltage is a voltage equal to a minimum distance to a recoverable area.

An embodiment of the present disclosure provides the power conversion system, wherein the phase current reconstruction unit is configured to compensate for a voltage in the opposite direction of the minimum voltage after measuring the DC-link current to maintain the average voltage.

An embodiment of the present disclosure provides the power conversion system that further includes a single DC-link current sensor disposed between the inverter and a DC power source, and the current flowing through the DC side of the inverter is measured using the single DC-link current sensor.

According to the embodiment of the present disclosure, it is possible to compensate for current reconstruction errors in a power conversion system using a single current sensor.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a drawing illustrating a conventional three-phase inverter system using a plurality of phase current sensors;

FIG. 2 is a drawing illustrating a conventional three-phase inverter system using a single current sensor,

FIG. 3 is a block diagram illustrating a control flow of a conventional three-phase surface-mounted permanent magnet synchronous motor using a DC-link current sensor;

FIG. 4 is a block diagram illustrating a power conversion system according to an embodiment of the present disclosure;

FIG. 5 is a drawing illustrating a three-phase inverter according to an embodiment of the present disclosure;

FIGS. 6A to 6H are drawings illustrating current flow depending on a switching state of a three-phase inverter according to an embodiment of the present disclosure;

FIG. 7A is a drawing illustrating one switching period of space vector pulse width modulation;

FIG. 7B is a drawing illustrating one half switching period of space vector pulse width modulation;

FIG. 8 is a drawing illustrating a dead zone;

FIG. 9 is a drawing illustrating minimum voltage injection according to an embodiment of the present disclosure;

FIG. 10 is a drawing illustrating one switching period of space vector pulse width modulation for explaining minimum voltage injection according to an embodiment of the present disclosure;

FIG. 11 is a drawing illustrating a current error occurring in minimum voltage injection according to an embodiment of the present disclosure;

FIGS. 12A to 12C are diagrams illustrating examples of switching waveforms of switching signal split according to an embodiment of the present disclosure;

FIG. 13 is a diagram illustrating an example of current reconstruction using switching signal split according to an embodiment of the present disclosure;

FIG. 14 is a flowchart illustrating a method of compensating for current reconstruction errors in a power conversion system according to an embodiment of the present disclosure;

FIG. 15 is a diagram illustrating a comparison between d-axis current and q-axis current in a case of control after compensation;

FIG. 16 is a diagram illustrating errors of d-axis current and q-axis current before and after compensation; and

FIG. 17 is a diagram illustrating a comparison between d-axis current and q-axis current in the case of control with current before compensation.

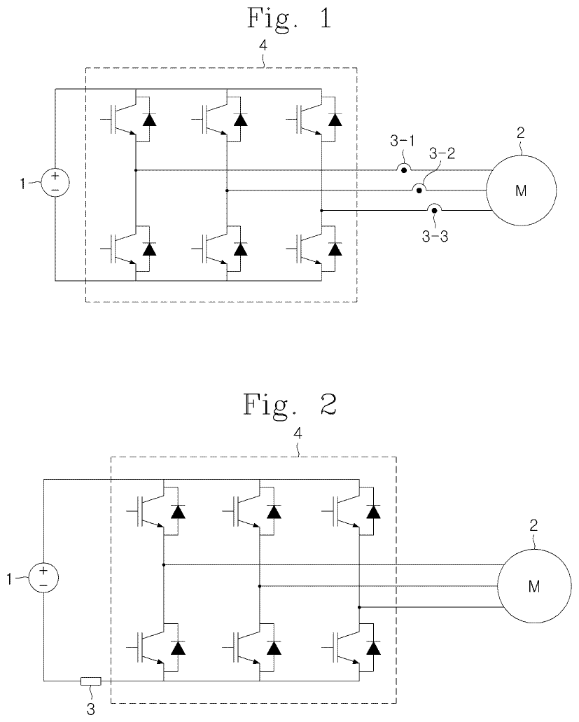

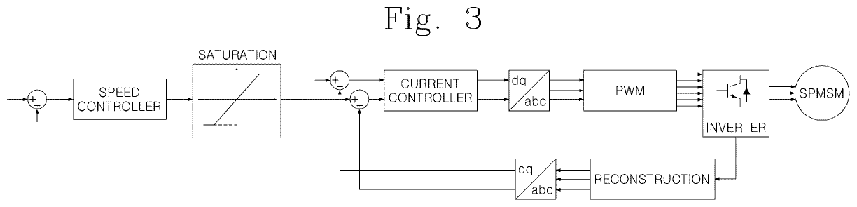

### DETAILED DESCRIPTION OF THE EXEMPLARY EMBODIMENTS

Hereinafter, the embodiments disclosed in this specification will be described in detail with reference to the attached drawings in which identical or similar components will be assigned the same reference numerals and redundant descriptions thereof will be omitted. The “module” and “unit” used for components in the following description are given or used interchangeably only for the convenience of drafting the specification, and do not have distinct meanings or roles in themselves.

In this description, the expression “include”, “is provided”, or “is configured” is intended to indicate certain characteristics, numbers, steps, operations, elements, parts, or combinations thereof, and should not be interpreted to exclude the existence or possibility of one or more other characteristics, numbers, steps, operations, elements, parts, or combinations thereof other than those described.

In addition, when describing the embodiments disclosed in this specification, a detailed description of a related known technology, which is determined to obscure the subject matter of the embodiments disclosed in this specification, will be omitted.

The attached drawings are only intended to facilitate easy understanding of the embodiments disclosed in this specification, and the technical ideas disclosed in this specification are not limited to the attached drawings, and should be understood to include all modifications, equivalents, or substitutes included in the scope of the present disclosure.

In addition, the disclosures of the papers cited throughout this specification are incorporated herein by reference in their entirety to more clearly explain the level of the technical field to which this application belongs and the present disclosure.

Hereinafter, the embodiments of the present disclosure will be described in detail with reference to the drawings.

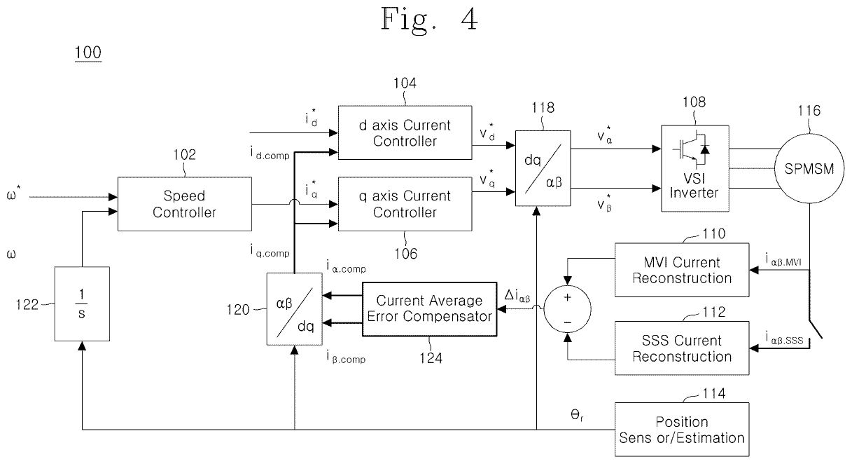

FIG. 4 is a block diagram illustrating a power conversion system according to an embodiment of the present disclosure.

A power conversion system 100 according to the embodiment of the present disclosure may be an inverter or converter system. FIG. 4 illustrates an inverter system as an example of a power conversion system according to an embodiment of the present disclosure. An inverter system controls an AC motor or the like using an inverter. The power conversion system 100 according to the embodiment of the present disclosure may use a single DC-link current sensor. In addition, it is desirable that the power conversion system 100 is operated in an environment with a constant load rather than an environment with a changing load.

The power conversion system 100 according to the embodiment of the present disclosure may include a speed controller 102, a d-axis current controller 104, a q-axis current controller 106, an inverter 108, a minimum voltage injection (MVI) current reconstruction unit 110, a switching signal split (SSS) current reconstruction unit 112, a rotor position/speed estimation unit 114, an AC motor 116, a coordinate conversion unit 118 or 120, an integrator 122, and a current average error compensator 124. The power conversion system 100 may be a three-phase power conversion system.

The speed controller 102 controls the speed of the AC motor 116, receives a speed command w*, and outputs current commands i_{d}* and i_{q}*.

The d-axis current controller 104 controls the current of the AC motor 116, and performs control regarding the current command i_{d}* output from the speed controller 102. The q-axis current controller 106 controls the current of the AC motor 116, and performs control regarding the current command i_{q}* output from the speed controller 102. The d-axis current controller 104 and the q-axis current controller 106 output voltage commands V_{d}* and V_{q}*, respectively.

A first coordinate conversion unit 118 and a second coordinate conversion unit 120 perform conversion between the αβ coordinate system (stationary coordinate system) and the dq coordinate system (rotating coordinate system).

The inverter 108 implements an actual voltage with the voltage commands V_{d}* and V_{q}* output from the current controllers 104 and 106. The inverter 108 may be a voltage source inverter (VSI).

The minimum voltage injection current reconstruction unit 110 restores the phase current by the minimum voltage injection (MVI) technique. The minimum voltage injection technique may be referred to in Paper 1 (J.-I. Ha, “Voltage Injection Method for Three-Phase Current Reconstruction in PWM Inverters Using a Single Sensor,” in IEEE Transactions on Power Electronics, vol. 24, no. 3, pp. 767-775, March 2009, doi: 10.1109/TPEL.2008.2009451.).

The switching signal split current reconstruction unit 112 reconstructs the phase current by the switching signal split (SSS) technique. The switching signal split technique may be referred to in Paper 2 (J. -S. Hwang, M.-S. Chae and H.-G. Choi, “Sensor-Less Drive of Ultra-Low Inductance SPMSM With DC-Link Single Current Sensor,” in IEEE Access, vol. 12, pp. 78959-78968, 2024, doi: 10.1109/ACCESS.2024.3405401.) and Paper 3 (J. S. Hwang, M. S. Chae, and H. K. Choi, (2024), “Average current recovery of three-phase inverter using a single DC-link current sensor using carrier phase inversion switching technique”, Journal of the Korean Institute of Power Electronics, 29 (1), 39-47, 10.6113/TKPE.2024.29.1.39).

The current reconstruction unit 110 or 112 may reconstruct the phase current using the DC-link current measured by a single current sensor installed at the DC side and switching patterns of respective switching elements of the inverter 108. The current reconstruction unit 110 or 112 provides the reconstructed phase current to the current average error compensator 124.

The rotor position/speed estimation unit 114 estimates the rotor position and speed of the AC motor 116 using an algorithm or a separate sensor.

The integrator 122 integrates an input signal with time to generate an output signal.

The current average error compensator 124 calculates a current reconstruction error using minimum voltage injection and/or switching signal split, and compensates for the current reconstruction error. This may increase the accuracy of current control and maintain THD (total harmonic distortion) characteristics.

In the embodiment of the present disclosure, the speed controller 102, the d-axis current controller 104, the q-axis current controller 106, and the first coordinate conversion unit 118 may be voltage command generators that apply voltage commands to the inverter 108. In addition, the current reconstruction units 110 and 112 may include a current average error compensator 124.

Table 1 shows parameters of the AC motor according to the embodiment of the present disclosure.

TABLE 1

| Items | Symbols | Values | Unit |
|---|---|---|---|
| DC-link voltage | V_{dc} | 15 | V |
| Number of poles | P | 2 | — |
| Wire resistance | Rₛ | 0.26 | Ω |
| Inductance | L_{d}, L_{q} | 31, 31 | μH |
| (d-axis, q-axis) | | | |
| Switching | f_{SW} | 30 | kHz |
| frequency | | | |

In the power conversion system 100 according to the embodiment of the present disclosure, the switching signal split technique has an advantage of being able to measure average current, although the current harmonic characteristics are not excellent at medium or high speeds. Therefore, when driving at medium or high speeds, the minimum voltage injection technique may be applied to reconstruct current and drive. In addition, the switching signal split technique may be used to further compensate for a current reconstruction error occurring within one switching period.

The switching signal split technique may split switching at points where current reconstruction errors occur in respective voltage sectors, thereby performing more precise current compensation. In order to compensate for the current reconstruction errors, the switching signal split may be performed once per several samplings (for example, once per 1,000 samplings) to sample the average current value for compensation. In this case, the timing for applying the switching signal split may be the point where the average current error occurs for each voltage sector.

The operation of the power conversion system 100 according to the embodiment of the present disclosure will be described in detail below.

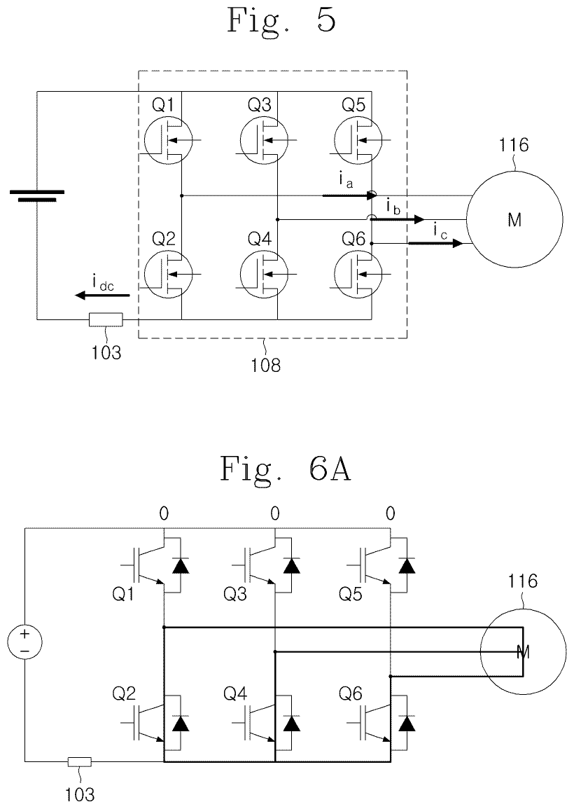

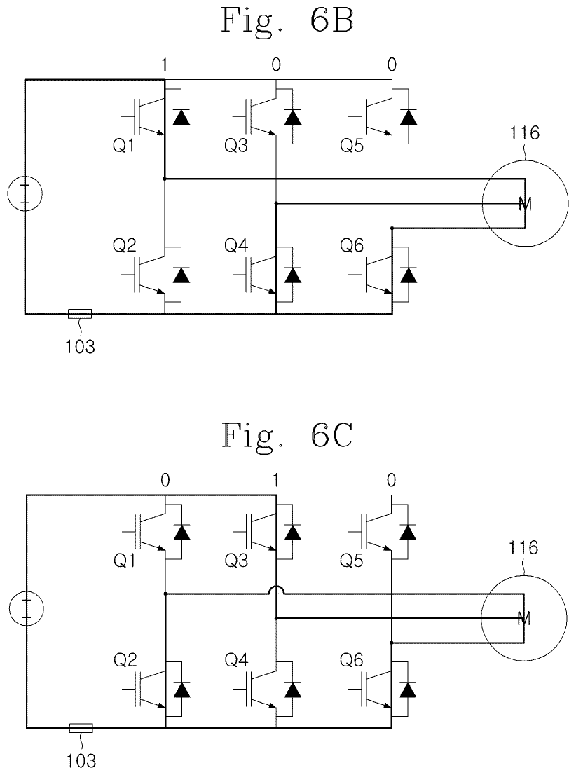

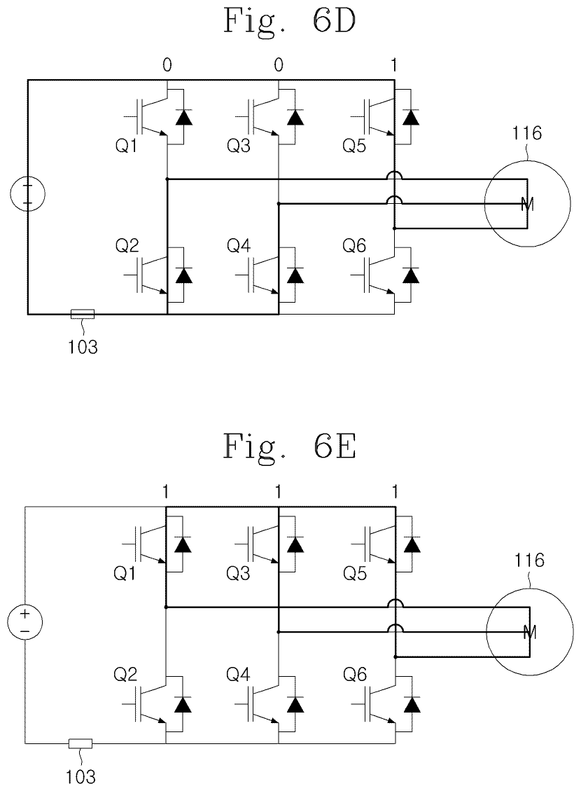

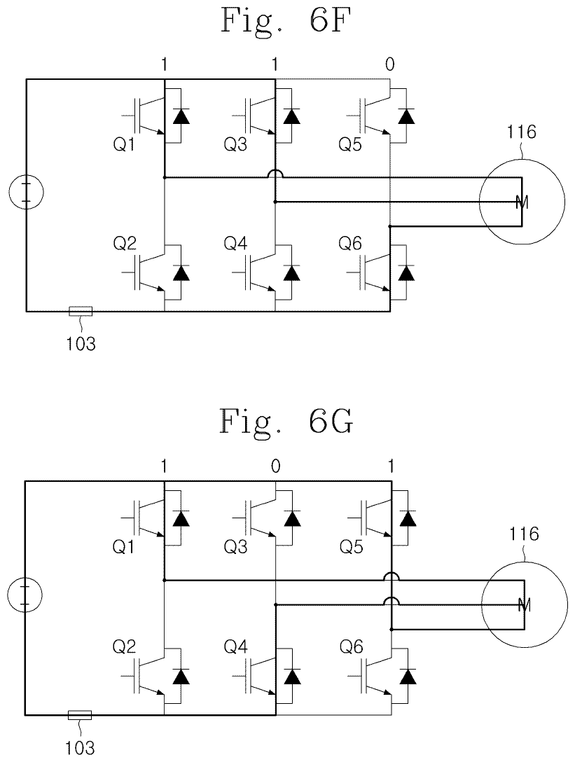

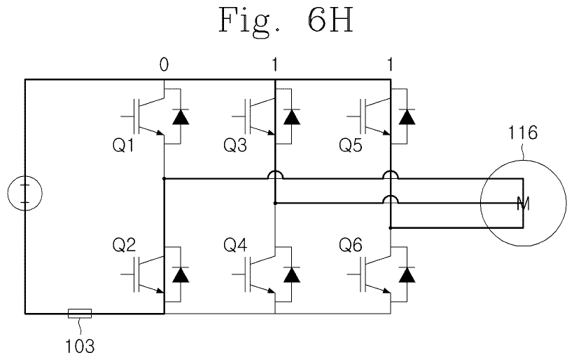

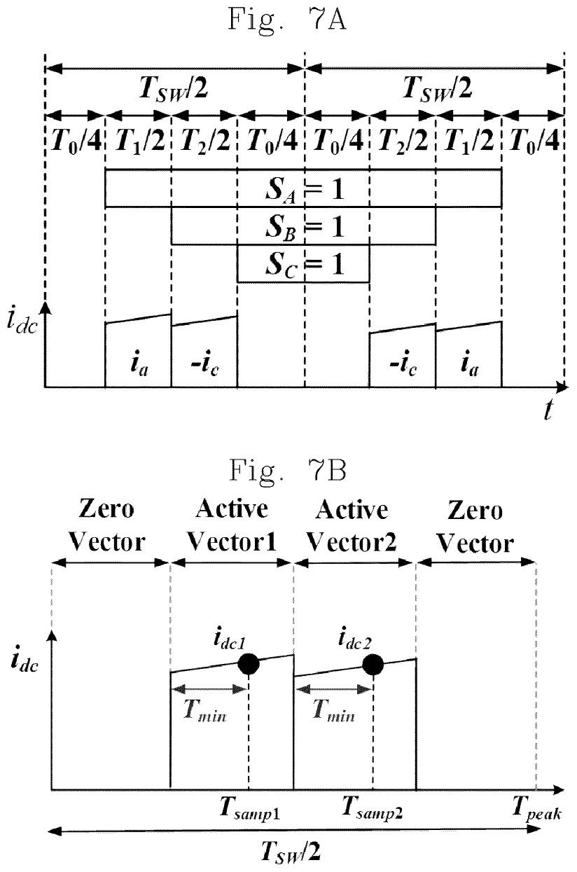

FIG. 5 is a drawing illustrating a three-phase inverter according to an embodiment of the present disclosure, and FIGS. 6A to 6H are drawings illustrating current flow depending on a switching state of a three-phase inverter according to an embodiment of the present disclosure.

Referring to FIG. 5, the AC motor 116 may be a three-phase motor or a three-phase surface-mounted permanent magnet synchronous motor (SPMSM). The AC motor 116 has a stator and a rotor including a resistor and an inductor. Respective phase terminals of the AC motor 116 are connected to the inverter 108, and when the phase current flows through the inductor, a magnetic field is formed to rotate the rotor.

In order to drive the AC motor 116, the inverter 108 may convert a DC voltage into a three-phase AC in the form of a pulse with an arbitrary variable frequency through pulse width modulation (PWM). The inverter 108 has six switching elements Q1 to Q6, and three pairs of switching elements connected in series are connected to the phase terminals of the three-phase AC motor 116, respectively. The upper switching elements Q1, Q3, and Q5 are connected to the (+) terminal of the DC power source, and the lower switching elements Q2, Q4, and Q6 are connected to the (−) terminal of the DC power source. The inverter 108 may be driven by a pattern of a space vector PWM (SVPWM) signal.

A single current sensor 103 is disposed between the inverter 108 and the DC power source and measures the current flowing in the DC terminal of the inverter 108. It is preferable that the current sensor 103 be a single DC-link current sensor.

Referring to FIGS. 6A to 6H, in the operation of the three-phase PWM inverter system, six switching elements of the inverter 108 are controlled to be turned on/off so that one of the upper switching elements Q1, Q3, and Q5 is turned on, and so that one of the lower switching elements Q2, Q4, and Q6, which has a different phase from that of the switching element turned on, is turned on. In addition, the three-phase PWM inverter system estimates the phase current of the AC motor 116 on the basis of the DC-link current measured from the single DC-link current sensor 103, and selectively switches the switching elements Q1 to Q6 on the basis of the phase current.

The switching elements Q1 to Q6 of the inverter 108 are controlled in such a way that one of the pair of switching elements is turned on, the other one is turned off. Therefore, when indicating the overall switching state of the inverter 108, the states of the upper switching elements Q1, Q3, and Q5 are indicated as 1 or 0. Here, 1 indicates a conducted state in which the switch is closed, and 0 indicates an open state of the switch.

When the switching state is (0, 0, 0) or (1, 1, 1), the information of the current flowing through the single DC-link current sensor 103 does not include phase current information. This is called a zero vector or a zero voltage vector. In the remaining switching states, excluding the zero vector, the phase current information is included in the information of the current flowing through the single DC-link current sensor 103. This is called an active vector or an active voltage vector.

The basic voltage vector has six active vectors and two zero vectors. Referring to FIG. 6A and FIG. 6E, the zero vector is (0, 0, 0) or (1, 1, 1) in which all of the upper or lower switching elements are turned off, respectively, so that no current flows to the motor 116. In this case, the numbers in the parentheses indicate the on and off states of the switching elements Q1, Q3, and Q5, respectively.

FIG. 6B shows an active vector (1, 0, 0) indicating that phase current iₐ is detected. FIG. 6C shows an active vector (0, 1, 0) indicating that phase current iₐ is detected. FIG. 6D shows an active vector (0, 0, 1) indicating that phase current i_{c} is detected. FIG. 6F shows an active vector (1, 1, 0) indicating that phase current −i_{c} is detected. FIG. 6G shows an active vector (1, 0, 1) indicating that phase current −i_{b} is detected. FIG. 6H shows an active vector (0, 1, 1) indicating that phase current −iₐ is detected.

In the basic voltage vector, six active vectors are arranged to have a phase difference of 60 degrees from each other, and the zero vector is located at the origin. When an arbitrary command voltage vector required for controlling the motor 116 is given, an SVPWM signal is generated so that a basic voltage vector obtained by decomposing the command voltage vector is applied.

When controlling in this manner, the inverter 108 is in one of eight states corresponding to combinations of on/off states of the switching elements Q1 to Q6. The SVPWM method generates an SVPWM signal using eight basic voltage vectors respectively corresponding to eight states. In addition, the DC-link current detected by the current sensor 103 in the section where each basic voltage vector is applied corresponds to one of the three phase currents flowing to the AC motor 116.

FIG. 7A is a drawing illustrating one switching period of space vector pulse width modulation, and FIG. 7B is a drawing illustrating one half switching period of space vector pulse width modulation;

Referring to FIG. 7A, one switching period (T_{sw}) is illustrated in the space vector pulse width modulation. S_{A}, S_{B}, and S_{C} are control signals of switching elements Q1, Q2, and Q3, respectively, and are switching signals of phase a, phase b, and phase c. Two different active vector combinations are obtained at half (T_{sw}/2) of the switching period in the space vector pulse width modulation. In FIG. 7A, information about a-phase current and c-phase current may be obtained. In this case, b-phase current may be calculated according to Kirchhoff's current law (iₐ+i_{b}+i_{c}=0). In this way, information about two phase currents may be obtained from two different active vectors for each switching period, and the remaining one phase current may be calculated by Kirchhoff's current law and used for control.

Meanwhile, the nonlinearity of the inverter makes it impossible to measure the DC-link current immediately at the time point where the active vector occurs. Therefore, as shown in FIG. 7B, it is necessary to perform measurement with a margin of the minimum active vector application time Tₘᵢₙ.

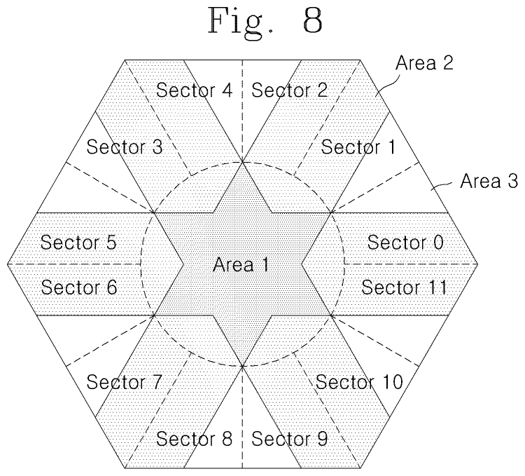

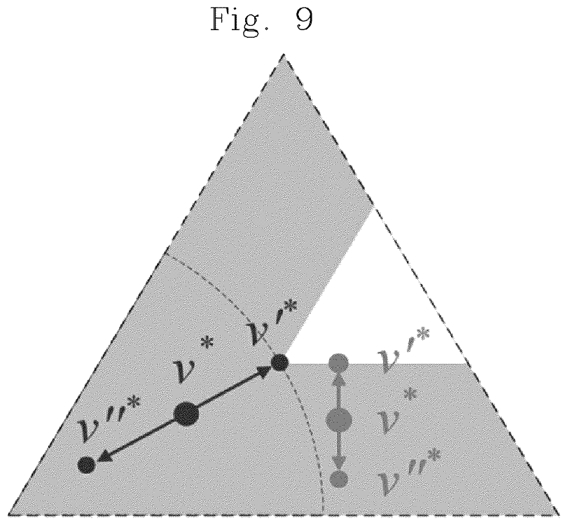

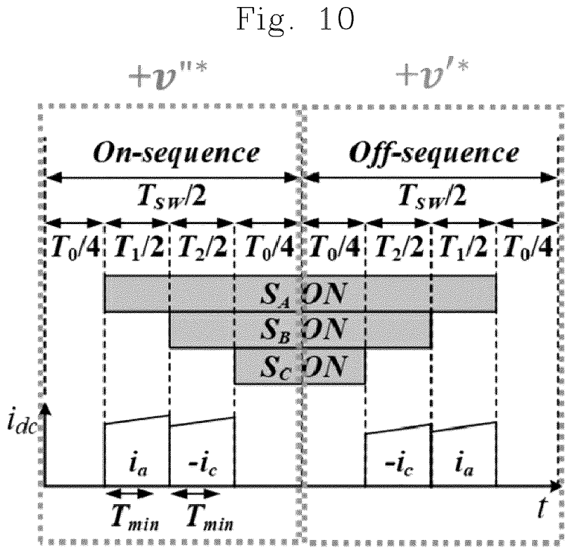

FIG. 8 is a drawing illustrating a dead zone, FIG. 9 is a drawing illustrating minimum voltage injection according to an embodiment of the present disclosure, and FIG. 10 is a drawing illustrating one switching period of space vector pulse width modulation for explaining minimum voltage injection according to an embodiment of the present disclosure.

Referring to FIG. 8, a voltage command v* of the three-phase power conversion system 100 rotates around a hexagon. In FIG. 8, Area 1 and Area 2, which are dark areas, are dead zones where the active vector application time is shorter than the minimum active vector application time Tₘᵢₙ. That is, the active vector application time is insufficient to sense the phase current in such areas.

Area 1 is a hexagram-shaped area where the application time for both active vectors is insufficient. Area 2 is a dark area, excluding Area 1, where the phase current may be sensed from one of the two active vectors. Area 3 is an area where two active vectors are secured, so that two phase currents may be sensed.

In the embodiment of the present disclosure, minimum voltage injection is applied to Area 1 and Area 2 where the active vector application time is insufficient to sense the phase current. The minimum voltage injection technique is a method for securing the insufficient active vector application time.

In order to apply the minimum voltage injection technique, the hexagon shown in FIG. 8 is divided into 12 sectors (Sectors 0 to 11). FIG. 9 illustrates two sectors (Sectors 0 and 1) among the 12 sectors. In FIG. 9, blue indicates the case where the output voltage command v* is located in Area 1 of the dead zone, and red indicates the case where the output voltage command is located in Area 2.

As shown in FIG. 9, if the output voltage command is located in the dead zone, the minimum voltage v′* is injected at the 1/2 switching period of the space vector pulse width modulation, thereby measuring the DC-link current. In this case, the minimum voltage v′* is the voltage equal to the minimum distance to the recoverable area (Area 3).

After measuring the DC-link current, the voltage v″* in the opposite direction of the minimum voltage v′* is compensated for in the remaining 1/2 switching period to maintain the average voltage. The relationship between the voltages is as shown in Equation 1 below.

$${v}^{*} = 0.5 * ( {v}^{′ *} + {v}^{″ *} ) \qquad [ Equation 1 ]$$

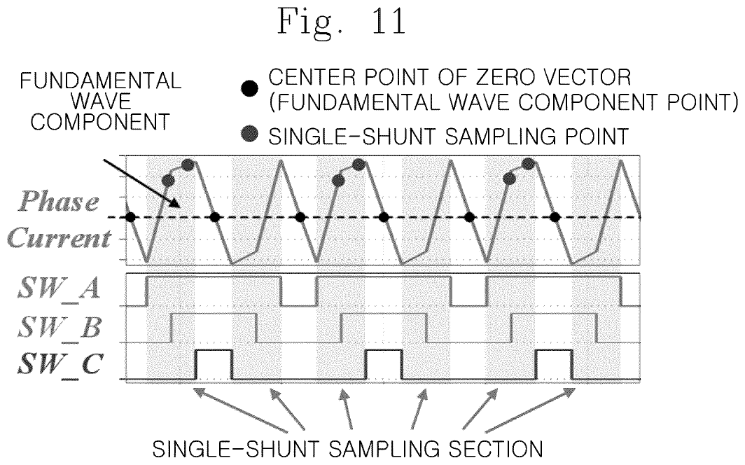

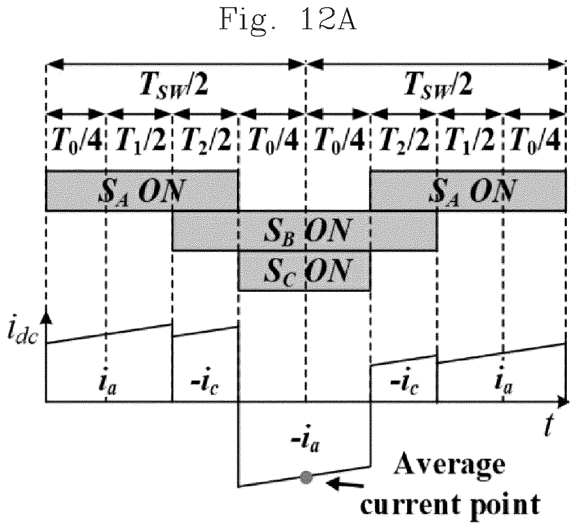

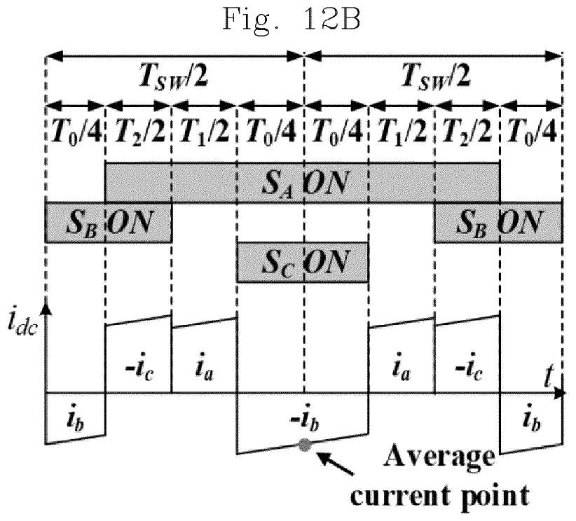

FIG. 11 is a drawing illustrating a current error occurring in minimum voltage injection according to an embodiment of the present disclosure.

As described above, the minimum voltage injection technique may solve the problem with the dead zone in the space vector pulse width modulation. However, as shown in FIG. 11, there is a difference between the sampling point and the point where the fundamental wave of the current occurs. This causes an error between the reconstructed phase current and the actual current measured by the current sensor. In FIG. 11, SW_A, SW_B, and SW_C represent S_{A}, S_{B}, and S_{C}, respectively.

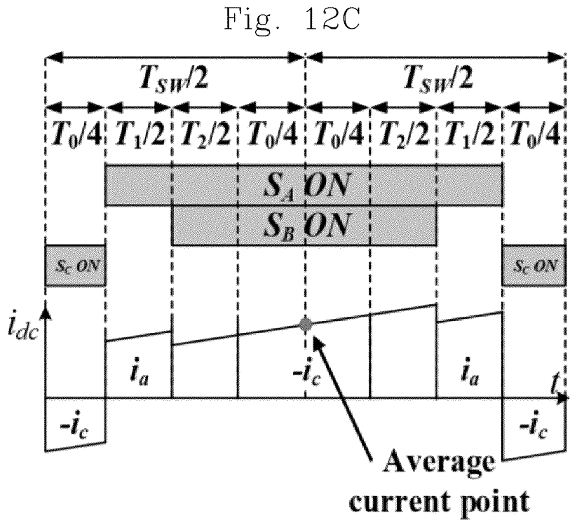

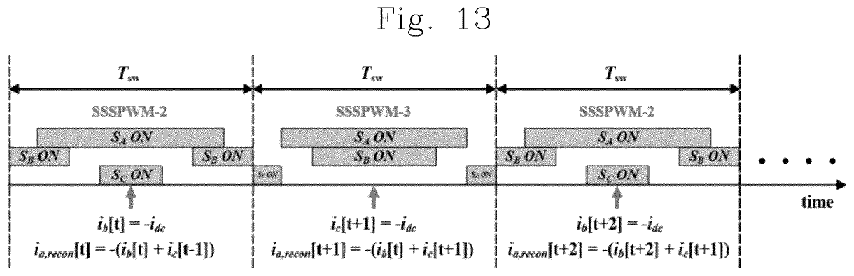

FIGS. 12A to 12C are diagrams illustrating examples of switching waveforms of switching signal split according to an embodiment of the present disclosure, and FIG. 13 is a diagram illustrating an example of current reconstruction using switching signal split according to an embodiment of the present disclosure

The switching signal split technique is a technique for reconstructing the average current. The switching signal split technique maintains the symmetry of switching and replaces the zero vector section with an active vector. Through this, the average current may be directly sampled at the center point of switching, which is the average current point, to restore the three-phase current.

When the inverter is driven by the switching signal split technique, an active vector is applied at the center point of the switching period where the phase current has an average value, and one phase current flows in the DC side, thereby sampling the average phase current at the center timing of the switching period. The red dot in FIGS. 12A to 12C represents the average current value.

If one of the three-phase signals is divided at the start and end points of the switching period in the space vector pulse width modulation, the switching waveform changes as shown in FIGS. 12A to 12C. FIG. 12A shows SSSPWM-1 in which the phase corresponding to

$${v}_{max}^{*}$$

is split, FIG. 12B shows SSSPWM-2 in which the phase corresponding to

$${v}_{mid}^{*}$$

is split, and FIG. 12C shows SSSPWM-3 in which the phase corresponding to

$${v}_{min}^{*}$$

is split. Here,

$${v}_{max}^{*}$$

represents the maximum value of the phase voltage command,

$${v}_{mid}^{*}$$

represents the median value, and

$${v}_{min}^{*}$$

represents the minimum value.

As shown in FIGS. 12A to 12C, one phase current may be sampled for each switching period. Therefore, SSSPWM-1, SSSPWM-2, and SSSPWM-3 may be applied alternately to reconstruct the average three-phase current value. FIG. 13 shows an example of applying SSSPWM-2 and SSSPWM-3 alternately. Through this, the current reconstruction error may be removed and the average current value may be measured.

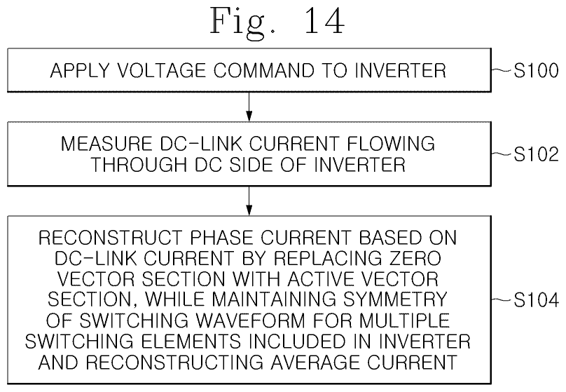

FIG. 14 is a flowchart illustrating a method of compensating for current reconstruction errors in a power conversion system according to an embodiment of the present disclosure.

A method of compensating for current reconstruction errors in a power conversion system according to an embodiment of the present disclosure includes a step of applying a voltage command to the inverter (S100), a step of measuring a DC-link current flowing through the DC side of the inverter (S102), and a step of reconstructing a phase current on the basis of the DC-link current (S104). In this case, the step of restoring the phase current may be a step of reconstructing the average current by replacing the zero vector section with an active vector section while maintaining the symmetry of the switching waveform for a plurality of switching elements included in the inverter.

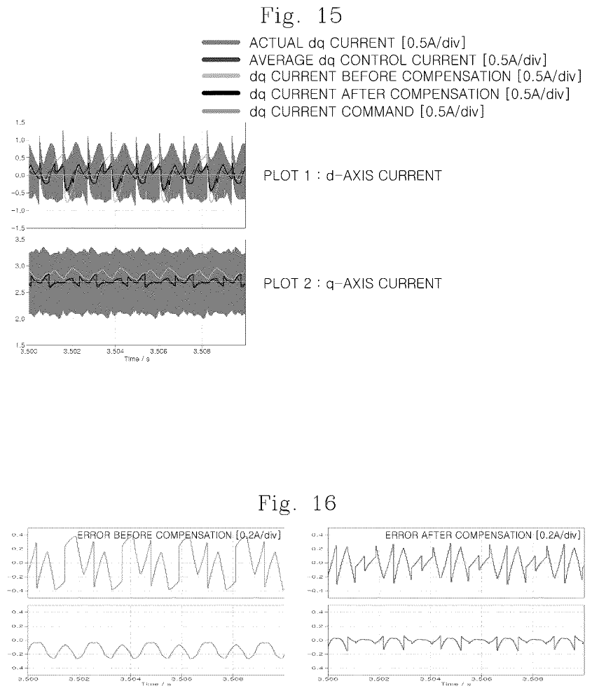

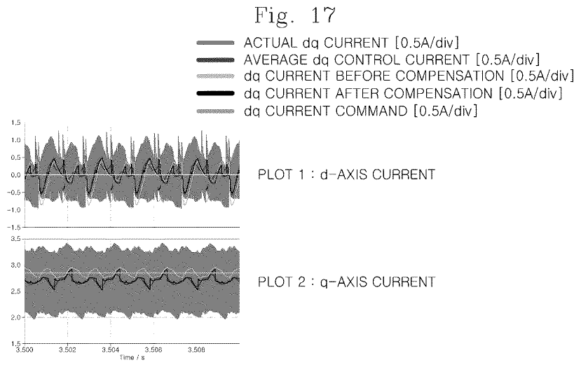

FIG. 15 is a diagram illustrating a comparison between d-axis current and q-axis current in a case of control after compensation, and FIG. 16 is a diagram illustrating errors of d-axis current and q-axis current before and after compensation.

The simulation was conducted using the PLECS power electronics simulator, and a speed control of a surface-mounted permanent magnet synchronous motor was performed as a representative example. The parameters of the motor applied to the simulation are shown in Table 1. The speed was 9000 RPM, and the applied load was 2 A.

Referring to FIG. 16, it can be seen that, if only the minimum voltage injection technique is applied before compensation, the q-axis current average error occurs in the negative direction. On the other hand, the error graph after compensation according to the embodiment of the present disclosure shows that the q-axis current average error converges to 0, so that the current command also converges to the average. In addition, it can be seen that the peak value of the d-axis current, which is an invalid component, also decreases.

FIG. 17 is a diagram illustrating a comparison between d-axis current and q-axis current in the case of control with current before compensation.

The simulation was conducted using the PLECS power electronics simulator, and the parameters and operating points of the motor in the simulation are the same as those in FIG. 15. Referring to FIG. 17, unlike FIG. 15, it can be seen that there is an average current error on the q-axis and that the invalid d-axis current significantly increases.

As described above, although the present disclosure has been described with specific details, such as specific components, and limited embodiments and drawings, these are provided only to help overall understanding of the present disclosure, and the present disclosure is not limited to the above-described embodiments, and those skilled in the art to which the present disclosure belongs may make various modifications and changes without departing from the essential characteristics of the present disclosure. Therefore, the idea of the present disclosure should not be limited to the described embodiments, and all technical ideas equivalent to the claims described below should be interpreted as being included in the scope of the present disclosure. In addition, the embodiments described above may be performed as a combination thereof as needed.

What is claimed is:

1. A method of compensating for current reconstruction errors in a power conversion system, the method comprising:
applying a voltage command to an inverter,
measuring a DC-link current flowing through a DC side of the inverter, and
reconstructing a phase current on the basis of the DC-link current,
wherein the restoring of the phase current comprises replacing a zero vector section with an active vector section, while maintaining symmetry of a switching waveform for a plurality of switching elements included in the inverter, and reconstructing an average current.

2. The method of claim 1,
wherein the reconstructing of the phase current comprises splitting one of three-phase signals within a switching period in space vector pulse width modulation.

3. The method of claim 2,
wherein the splitting one of the three-phase signals comprises at least one of:
splitting a phase signal corresponding to
$${v}_{max}^{*}$$
to generate a first switching waveform;
splitting a phase signal corresponding to
$${v}_{mid}^{*}$$
to generate a second switching waveform; and
splitting a phase signal corresponding to
$${v}_{min}^{*}$$
to generate a third switching waveform.

4. The method of claim 3,
wherein the reconstructing of the phase current comprises applying two switching waveforms alternately, among the first switching waveform, the second switching waveform, and the third switching waveform, and reconstructing the average current.

5. The method of claim 1,
wherein the reconstructing of the phase current comprises sampling an average current at a center point of switching, thereby reconstructing the phase current.

6. The method of claim 1,
wherein the inverter is controlled on the basis of space vector pulse width modulation, and
wherein the method further comprises, when an active vector application time of an output voltage command is shorter than a minimum active vector application time (Tₘᵢₙ), injecting a minimum voltage and measuring the DC-link current.

7. The method of claim 6,
wherein the minimum voltage is a voltage equal to a minimum distance to a reconstructible area.

8. The method of claim 7,
further comprising, after measuring the DC-link current, compensating for a voltage in the opposite direction of the minimum voltage to maintain the average voltage.

9. The method of claim 1,
wherein the measuring of the current flowing through the DC side of the inverter comprises measuring the current using a single DC-link current sensor disposed between the inverter and a DC power source.

10. A power conversion system comprising:
a voltage command generator configured to apply a voltage command to an inverter;
a current sensor configured to measure a DC-link current flowing through a DC side of the inverter; and
a phase current reconstruction unit configured to reconstruct a phase current on the basis of the DC-link current, and
wherein the phase current reconstruction unit comprises a current restoration error compensator configured to compensate for a current reconstruction error by replacing a zero vector section with an active vector section, while maintaining symmetry of a switching waveform for a plurality of switching elements included in the inverter, and reconstructing an average current.

11. The power conversion system of claim 10,
wherein the phase current reconstruction unit is configured to split one of three-phase signals within a switching period in space vector pulse width modulation.

12. The power conversion system of claim 11,
wherein the phase current reconstruction unit is configured to generate at least one of a first switching waveform obtained by splitting a phase signal corresponding to
$${v}_{max}^{*} ,$$
a second switching waveform obtained by splitting a phase signal corresponding to
$${v}_{mid}^{*} ,$$
and a third switching waveform obtained by splitting a phase signal corresponding to
$${v}_{min}^{*} ,$$
among the three-phase signals.

13. The power conversion system of claim 12,
wherein the phase current reconstruction unit is configured to apply two switching waveforms alternately, among the first switching waveform, the second switching waveform, and the third switching waveform and reconstruct the average current.

14. The power conversion system of claim 11,
wherein the phase current reconstruction unit is configured to sample an average current at a center point of switching, thereby reconstructing the phase current.

15. The power conversion system of claim 10,
wherein the inverter is controlled on the basis of space vector pulse width modulation, and
wherein the phase current reconstruction unit is configured to inject, when an active vector application time of an output voltage command is shorter than a minimum active vector application time (Tₘᵢₙ), a minimum voltage and measure the DC-link current.

16. The power conversion system of claim 15,
wherein the minimum voltage is a voltage equal to a minimum distance to a reconstructible area.

17. The power conversion system of claim 16,
wherein the phase current reconstruction unit is configured to compensate for a voltage in the opposite direction of the minimum voltage after measuring the DC-link current to maintain the average voltage.

18. The power conversion system of claim 10,
further comprising a single DC-link current sensor disposed between the inverter and a DC power source,
wherein the current flowing through the DC side of the inverter is measured using the single DC-link current sensor.
